(19) United States
(12) Patent Application Publication
(10) Pub. No.: US 2023/0023676 A1
(43) Pub. Date: Jan. 26, 2023

(54) ELECTRICAL TRANSMISSION DEVICE AND MOTOR VEHICLE

(71) Applicant: Valeo Schalter und Sensoren GmbH, Bietigheim-Bissingen (CN)

(72) Inventor: Stefan Müller, Bietigheim-Bissingen (DE)

(73) Assignee: Valeo Schalter und Sensoren GmbH, Bietigheim-Bissingen (DE)

(21) Appl. No.: 17/785,623

(22) PCT Filed: Dec. 10, 2020
(86) PCT No.: PCT/EP2020/085544

§ 371 Date: Jun. 15, 2022

(30) Foreign Application Priority Data
Dec. 18, 2019 (DE) 10 2019 134 905.2

(51) Int. Cl. B60R 16/027; H01R 13/652; H01R 35/02

(52) U.S. Cl. CPC B60R 16/027; H01R 13/652; H01R 35/025; H01R 2201/26

(57) ABSTRACT

The present invention relates to an electrical transmission device (10), in particular a coil spring arrangement (10), for a motor vehicle and to a motor vehicle, wherein the electrical transmission device (10) has a strip-type electrical transmission element (2), in particular a coil spring (2), which is designed and configured, in a functional installation state of the electrical transmission device (10) in a vehicle, to form an electrical connection, in particular a connection for signal and/or energy transmission, between a component (3A) arranged on the vehicle body side and/or an assembly (3) arranged on the vehicle body side, and a component (4A) arranged on the steering input side, in particular on the steering wheel side, and/or an assembly (4) arranged on the steering input side, wherein the electrical transmission device (10) furthermore has at least one electrical discharge apparatus (5) for discharging an electrostatic charge of the electrical transmission device (10) which is electrically connected to the strip-type electrical transmission element (2) and is designed and configured such that an electrostatic charge of the electrical transmission device (10) can be discharged at least in part via the electrical discharge apparatus (5).

The present invention relates to an electrical transmission device, in particular a coil spring arrangement, for a motor vehicle, wherein the electrical transmission device has a strip-type electrical transmission element, in particular a winding strip or a coil spring, which, in a functional installation state of the electrical transmission device in a motor vehicle, is designed and configured to form an electrical connection, in particular a connection for signal and/or energy transmission, between a component arranged on the vehicle structure side or an assembly arranged on the vehicle structure side, for example a steering column module, and a component or assembly arranged on the steering wheel side, for example a steering wheel module, such as an airbag, which can be integrated into a steering wheel.

The present invention further relates to a motor vehicle having such an electrical transmission device.

The use of generic electrical transmission devices, which are designed, for example, as described above, is generally known from the prior art, in particular from the field of motor vehicle technology. As mentioned, such electrical transmission devices can be used in motor vehicles for providing electrical connections, in particular for signal and/or energy transmission. This may include, for example, the transmission of an electrical voltage or the like, in particular also between components of a motor vehicle that are movable relative to one another. Known in this context is, among other things, in particular the use of so-called “coil springs” for signal transmission between components that can be integrated or are integrated in the rotatable steering wheel, such as an airbag, steering wheel switch units or the heating elements of a steering wheel heating system, and associated components arranged in a fixed position in the vehicle, such as an associated airbag control unit and/or another control unit arranged fixed to the vehicle at the upper end of the steering column, for example a control unit for controlling the heating power of heating elements of a steering wheel heating system.

In accordance with the terminology used in the present invention, the airbag and heating element each correspond to the steering wheel module. By contrast, the airbag control unit or one or more other control units or components or assemblies which are or can be arranged fixed to the vehicle at the upper end of the steering column represent a component arranged on the vehicle structure side and/or an assembly arranged on the vehicle structure side within the meaning of the present invention.

A coil spring as an example of a strip-type electrical transmission element used within the scope of the present invention is in particular a spirally windable or wound cable, in particular a ribbon cable, with a plurality of electrical conductors which are electrically insulated from each other. The conductors can be formed as conductor tracks insulated from one another, which can be arranged in one or more planes. Due to the spiralled winding, which enables a resilient, flexible and thus compensating electrical cable connection, coil springs are particularly suitable for electrical connection between components integrated in the rotatable steering wheel, such as an airbag or heating elements of a steering wheel heater, and components arranged on the vehicle structure side and/or assemblies arranged on the vehicle structure side, such as an associated airbag control unit or one or more other control units, for example for controlling a heating function of a steering wheel heater. The winding can also be implemented here in loops. It is known to design coil springs in such a way that they can be accommodated at least partially by a so-called coil spring cassette, i.e., a housing appropriately designed for this purpose, in particular to be at least partially rolled up therein. In a functional installation state in the motor vehicle, the coil spring cassette together with the coil spring accommodated therein is usually arranged between the steering wheel and a steering column lever housing. Alternatively, the coil spring cassette can also be designed completely separately, so that the coil spring cassette is not installed in conjunction with or in the vicinity of a steering column lever housing.

In addition, coil spring arrangements are known in which the coil spring is at least partially accommodated directly by the steering wheel and/or by a component or assembly on the vehicle structure side instead of in a separate coil spring housing in the form of a coil spring cassette, i.e., without a separate housing in the form of a coil spring cassette which completely accommodates the coil spring, wherein it is known in particular to close the accommodation space for the coil spring in the steering wheel and/or in the component or assembly on the vehicle structure side by means of a separate cover similar to a housing cover, wherein it is possible for the coil spring to be accommodated at least partially by the steering wheel or a steering wheel component and/or at least partially by the steering column lever housing.

The development of modern motor vehicles has led to an increasing relevance of electronic functional units implemented in motor vehicles or electrically controlled functional units together with the associated electrical connections. High demands are placed on these units, especially when it comes to ensuring reliable functionality and safety. In particular, reliable and durable functionality must be ensured for those functional units that directly affect the safety of the vehicle occupants, such as an airbag module arranged in the steering wheel of a motor vehicle. Such an airbag module usually comprises an airbag and a gas generator. In a corresponding crash situation of the motor vehicle, which is also recognized as such, gas flows from the gas generator into the airbag and inflates it so that the airbag unfolds in the direction of the vehicle occupant. In order to prevent undesired activation of the airbag, for example by an electrostatic charge and a subsequent uncontrolled electrical discharge that can lead to undesired deployment of the airbag, the use of electrical discharge devices that are designed to discharge electrostatic charges from the airbag module to a vehicle structure, in particular a vehicle body, in a direct and controlled manner is known.

The basic problem of protecting electronic units or components of a motor vehicle from electrostatic charges or for discharging electrostatic charges is generally known. With reference to the specific example of an airbag module integrated in the steering wheel of a motor vehicle, the dissipation of electrostatic charges is ensured by means of discharge devices provided in the region of the steering wheel or the airbag module. Such discharge devices are usually referred to as ESD protection devices, wherein the acronym ESD stands for “ElectroStatic Discharge”.

Corresponding discharge devices or corresponding arrangements with corresponding discharge devices are known, for example, from DE 196 29 009 A1, DE 696 14 984 T2, DE 10 2004 015 755 B3, DE 10 2009 041 712 A1 or DE 10 2005 004 452 A1.

Inter alia, a motor vehicle gas generator which has a gas generator arranged in a container holding an airbag is known from DE 10 2004 015 755 B3. In that case, the gas generator and/or the container are electrically grounded. To dissipate electromagnetic radiation, the gas generator and any associated diffuser have capacitive grounding with the container, which enables electrostatic charges from the gas generator and/or the diffuser to be dissipated to at least one other vehicle part with a high-impedance grounding.

DE 10 2005 004 452 A1 discloses an airbag housing in which a gas generator can be accommodated, wherein the airbag housing is made of plastic and can be attached to a motor vehicle. An electrically conductive material is embedded in the plastic in such a way that electrostatic charges can be dissipated from the gas generator to the motor vehicle via the electrically conductive material.

With the known discharge devices—usually located on the steering wheel side in the region of the airbag—a basic dissipation of electrostatic charges can indeed be ensured. The disadvantage of prior art solutions, however, is that the installation and replacement of the discharge devices is very complex.

It is therefore the object of the present invention to provide a generic electrical transmission device for a motor vehicle which permits simpler assembly and/or simpler replacement of the discharge device, and a motor vehicle having such an electrical transmission device.

This object is achieved in accordance with the invention by en electrical transmission device and by a motor vehicle comprising an electrical transmission device having the features according to the respective independent claims. Advantageous embodiments of the invention are the subject of the dependent claims, the description and the associated figures.

An electrical transmission device according to the invention is in particular a coil spring arrangement and is preferably designed for a motor vehicle and has a strip-type electrical transmission element, in particular a coil spring, which, in a functional installation state of the electrical transmission device in a motor vehicle, is designed and configured to establish an electrical connection, in particular a connection for signal and/or energy transmission, between a component arranged on the vehicle structure side and/or an assembly arranged on the vehicle structure side, for example a stator which can be connected in a rotationally fixed manner to a steering column and/or a steering column module, and a component arranged on the steering input side, in particular on the steering wheel side, and/or an assembly arranged on the steering input side, for example a rotor which can be connected for conjoint rotation to a steering input device, such as a steering wheel, and/or a steering wheel module which can be integrated into a steering wheel, such as an airbag.

An electrical transmission device according to the present invention is characterized in that the electrical transmission device further comprises at least one electrical discharge device for dissipating an electrostatic charge of the electrical transmission device, wherein the discharge device is electrically connected to, in particular electrically contacted with the strip-type electrical transmission element and is designed and configured in such a way that an electrostatic charge of the electrical transmission device, in particular at least one electrostatic charge of the strip-type electrical transmission element, can be dissipated at least partially, preferably completely, via the electrical discharge device.

A significant advantage of an electrical transmission device according to the invention lies in particular in the fact that, on the one hand, the discharge device is easy to assemble and, on the other hand, electrostatic charges which arise in the region of the strip-type electrical transmission element, for example as a result of friction between the strip-type electrical transmission element and itself, particularly in the case of a spiralled winding, or on a housing part, can be dissipated directly at the point of origin. Rather, voltages generated by an electrical charge in the region of the transmission device can be dissipated directly and immediately from the transmission device and do not have to be dissipated via one or more ESD protection devices associated with the airbag, for example.

With a correspondingly suitable arrangement of the discharge device, in particular by a simply realizable arrangement of this in the region of the connection side on the steering input side, a transmission device according to the invention can be used to prevent in a simple manner a transfer of electrostatic charges, which can arise during operation in the region of the transmission device, to components on the steering input side, in particular an airbag or the like.

A further, key advantage of an electrical transmission device according to the invention is that it also enables the dissipation or discharge of electrostatic charges in the event of damage to the strip-type electrical transmission element, in particular even if, for example, there is no longer a continuous electrical connection between the component on the vehicle structure side and/or the assembly on the vehicle structure side and the component on the steering input side and/or the assembly on the steering input side in a functional installation state in a vehicle, for example as the result of a strip break, since the discharge device provided in accordance with the invention and electrically connected to the strip-type electrical transmission element, assuming a correspondingly advantageous arrangement, design and contacting of the latter with the strip-type transmission element, means that no insulated strip portions can remain without a connection to a discharge device and accumulate electrostatic charge.

With an electrical transmission device according to the invention, an electrical connection, in particular a connection for power and/or signal transmission, can thus be established in a particularly simple and advantageous manner between one or more components and/or assemblies arranged in a fixed position (on the vehicle structure side in the vehicle), for example an airbag control unit, and one or more components and/or assemblies integrated in a rotatable steering wheel, for example an airbag and/or a steering wheel heater, while at the same time ensuring that electrostatic charges are dissipated directly from the electrical transmission device, in particular without the need for recourse to one or more discharge devices of other components.

In the sense of the invention, an electrical transmission device—as already mentioned at the outset—is understood to be a device which enables an electrical connection between two components and/or groups of components, preferably for signal and/or energy transmission, wherein an electrical transmission device in the sense of the invention particularly preferably enables an electrical connection for energy transmission, in particular for voltage and power supply, and/or an electrical connection for signal transmission, in particular for cable-based signal transmission.

A transmission device according to the invention can be used in particular in motor vehicles. In other words, a transmission device according to the invention is configured in particular for use in a motor vehicle. In this application, the electrical transmission device is preferably a coil spring arrangement, which is configured in particular to be arranged in the steering column lever region of a motor vehicle, i.e., in the region at the upper end of the steering column in the region of the so-called steering column module.

The designation “coil spring arrangement” in this case refers to the fact that this, i.e., the arrangement, according to the present invention has further components in addition to a coil spring as a strip-type electrical transmission element, namely at least one electrical discharge device. This is—as also mentioned at the outset—electrically connected to, in particular electrically contacted with the strip-type electrical transmission element, i.e., in this case to the coil spring, in accordance with the invention. The “coil spring arrangement” thus comprises not only a coil spring, but at least in addition also at least one discharge device, which is electrically connected to, in particular contacted with the strip-type electrical transmission element, and can furthermore comprise further components.

As already mentioned at the outset, a so-called coil spring is an exemplary but preferred example of a strip-type electrical transmission element within the scope of the present invention, wherein a coil spring is in particular at least one cable which can be wound up or is wound up spirally, in particular a ribbon cable, with a plurality of electrical conductors which are electrically insulated from one another. The conductors can be formed as conductor tracks insulated from one another, which can be arranged in one or more planes and preferably extend in parallel over the length of the coil spring.

A coil spring can be formed in one piece, i.e., can be a continuous ribbon cable in which the conductor tracks preferably run continuously from a first ribbon end to a second ribbon end. Alternatively, the coil spring can also be composed of a plurality of portions arranged one after the other or one above the other, i.e., in a plurality of planes, which are in particular each suitably electrically conductively connected to one another and/or are correspondingly suitably electrically insulated from one another. In the case of a multi-part design, suitable connecting means can be provided between the components of the coil spring in order to ensure electrical connection of the individual portions. The connecting means can be designed, for example, as plug connectors or the like. To establish an electrical connection between the conductor tracks of the various portions, the conductor tracks can also be soldered or welded directly to one another.

Due to the spiralled winding, which enables a resilient, flexible and thus compensating electrical cable connection, coil springs are particularly suitable for electrical signal and/or energy transmission between components and/or assemblies that can be moved relative to one another, in particular for electrical connection between components integrated in the rotatable steering wheel, such as an airbag or heating elements of a steering wheel heater, and components arranged on the vehicle structure side and/or assemblies arranged on the vehicle structure side, such as an associated airbag control unit or one or more other control units, for example for controlling a heating function of a steering wheel heater.

If the strip-type electrical transmission element is a coil spring, it is preferably designed to be at least partially accommodated by a so-called coil spring cassette, i.e., a housing designed accordingly for this purpose, in particular to be able to be rolled up at least partially therein.

For the purposes of the present invention, an “electrical connection” is generally understood to mean an electrical connection between two connection partners (for example the strip-type electrical transmission element and the discharge device) which is designed in such a way that it is possible to dissipate electrostatic charges via the connection, wherein it is possible for the connection partners to be electrically connected to one another in particular directly, i.e., without one or more further components in between, or indirectly, i.e., via at least one component in between.

An “electrical discharge device” in the context of the present invention is basically in particular any device that can be electrically connected or contacted directly or indirectly with the electrical transmission element and is designed and configured to discharge electrostatic charges, in particular overvoltages. An electrical discharge device need not necessarily be a physically insulated component or part, such as a Zener diode or Z-diode, a varistor or the like. A coating, a housing (part), a carrier material, an appropriately formed plug made, for example, of an appropriately suitable material, an appropriately formed cable sheathing or the like can also function so to speak as an electrical discharge device in the sense of the invention, both alternatively and additionally.

An electrical transmission device according to the invention can have only one electrical discharge device or also a plurality of electrical discharge devices. In the latter case, the electrical discharge devices can also readily be designed differently. In other words, a transmission device according to the invention can have a plurality of differently designed discharge devices.

When an electrical transmission device according to the invention, in particular a coil spring arrangement, is used in a motor vehicle, it serves in particular to establish an electrical connection between a component arranged on the vehicle structure side and/or an assembly arranged on the vehicle structure side and a component arranged on the steering input side and/or an assembly arranged on the steering input side.

An example of a component arranged on the steering input side in this context is a rotor that can be connected for conjoint rotation to a steering input device, such as a steering wheel, and/or a steering wheel module that can be integrated into a steering wheel, such as an airbag or a heating element of a steering wheel heater. In this context, a stator that can be connected to a steering column for conjoint rotation, an airbag control unit, a steering column module or another control unit, for example a control unit for controlling a heating function of a steering wheel heater, can be mentioned as an example of a component arranged on the vehicle structure side.

Furthermore, it should be noted at this point that a “steering input device” within the meaning of the invention is to be understood to include, in addition to a steering wheel, also other devices, such as joysticks, touchpads and/or correspondingly designed other electronic input means, insofar as a steering input can be applied via these and thus a steering arrangement of the vehicle can be controlled and/or a steering movement of at least some of the steerable wheels of an associated motor vehicle can be effected, wherein the steering input device can at least temporarily or permanently be directly and mechanically in operative connection to a steering system or steering gear (as in a conventional steering system) and/or can at least temporarily or permanently generate only one or more signals for initiating the steering movement as the consequence of an actuation of the steering input device (as in a steer-by-wire steering system).

In the sense of the present invention and with reference to a use of the electrical transmission device in a motor vehicle, an “arrangement on the vehicle structure side” is understood to mean in particular a fixed arrangement in the motor vehicle, in particular an arrangement on the body side. Correspondingly, an “arrangement on the steering input side” is to be understood as an arrangement in which the component or assembly in question is arranged together with the steering input device, in particular is connected to the latter for conjoint rotation, for example a steering wheel, and/or is integrated in the latter. In the case of a steering wheel, the component or assembly arranged on the steering wheel side particularly preferably rotates with the steering wheel when the steering wheel rotates in this case.

In addition to the examples already mentioned of an airbag integrated in a steering wheel or a steering wheel heater as components or assemblies on the steering input side, in modern motor vehicles further functional elements are frequently arranged in the region of the steering wheel or integrated therein, for example in the form of switches or the like. These functional elements on the steering input side can also be connected, in particular alternatively or additionally, in a functional installation state of an electrical transmission device according to the invention in a vehicle, via the electrical transmission device, in particular via the strip-type transmission element, to at least one component on the vehicle structure side or body side and/or to at least one assembly on the vehicle structure side, such as an electrical load, a (different) control unit, for example to a control unit of an on-board entertainment system, a speed control system, an air conditioning system, a radio, a display or a navigation system or the like.

In an advantageous embodiment of an electrical transmission device according to the present invention, the electrical transmission device further comprises at least one housing part of a housing, in particular a complete housing, for accommodating the strip-type transmission element, wherein the strip-type electrical transmission element is preferably accommodated at least partially by the at least one housing part, wherein in particular at least one discharge device is electrically connected to, in particular electrically contacted with this at least one housing part in such a way that at least one electrical charge of the housing part can be dissipated via the discharge device, which is electrically connected to the at least one housing part, in particular is electrically contacted with the latter. The at least one housing part can be part of a component arranged on the vehicle structure side and/or an assembly arranged on the vehicle structure side or a component arranged on the steering input side and/or an assembly arranged on the steering input side. Further housing parts can cooperate with said housing part, in particular to form a common housing. The housing can also be a housing separate from the components/assemblies on the vehicle structure side or steering input side. With reference to the example of an electrical transmission device according to the invention designed as a coil spring arrangement, the housing can in particular be a single-part or multi-part coil spring cassette. In this context, the at least one housing part can in particular be made of plastic, wherein the at least one housing part particularly preferably has in its interior as far as possible a smooth, friction-reducing surface in order to reduce friction between the housing part and the strip-type electrical transmission element, wherein it is possible alternatively or additionally to use a grease to reduce friction and noise development. Preferably, the material or the substance from which the at least one housing part is produced is particularly preferably alternatively or additionally selected in such a way that an electrostatic charge is as low as possible and/or is dissipated or discharged again as quickly as possible in a controlled manner, wherein the housing part preferably has a correspondingly suitable, defined electrical conductivity or a defined electrical resistance for this purpose. In other words, alternatively or additionally, at least one housing part can also itself form an electrical discharge device or at least a part thereof, which will be explained further later.

As already mentioned at the outset, an electrical transmission device configured in accordance with the present invention has, in accordance with the invention, at least one electrical discharge device which is electrically connected to the strip-type electrical transmission element. In addition, the at least one electrical discharge device connected to the strip-type electrical transmission element can also be electrically connected to at least one housing part, in order to thus be able to efficiently dissipate not only electrostatic charges arising in the region of the strip-type electrical transmission element, but also electrostatic charges arising at the at least one housing part.

Furthermore, in addition to the at least one electrical discharge device connected to the strip-type electrical transmission element, the transmission device can also have one or more further electrical discharge devices. These may also be electrically connected to, in particular contacted with the electrical transmission element, or also may not be electrically connected to the strip-type electrical transmission element and may only be electrically connected to, in particular electrically contacted with the at least one housing part. An electrical connection of at least one electrical discharge device with the strip-type transmission element and at least one housing part is also conceivable.

By using a plurality of electrical discharge devices, which are preferably electrically connected to different components of the electrical transmission device (for example the strip-type electrical transmission element and/or at least one housing part), the robustness of the electrical transmission device as such as well as the operational reliability and the functional safety of components and/or assemblies electrically connected via the transmission device can be increased.

Thus, an electrical transmission device according to the invention allows electrostatic charges generated in the region of the strip-type electrical transmission element and electrostatic charges generated in the region of the at least one housing part to be dissipated via different or the same electrical discharge devices.

The at least one housing part can be part of a separate housing, in particular part of a housing designed to accommodate a coil spring, preferably part of a so-called coil spring cassette, wherein the strip-type transmission element, in particular a coil spring, can preferably be at least partially rolled up therein, wherein this separate housing, in particular the coil spring cassette, is particularly preferably designed here, in a functional installation state in the motor vehicle, to be arranged, together with the coil spring accommodated therein, between the steering wheel and a steering column lever housing. A separate housing, in particular a coil spring cassette, enables a particularly simple installation of an electrical transmission device in a vehicle. The housing can be of one-piece or multi-piece design.

The at least one housing part can also be part of a steering input device or of an assembly on the steering input side or of a component on the steering input side, for example part of a steering wheel, or can be part of a component on the vehicle structure side or of an assembly on the vehicle structure side, and can be designed to directly accommodate the strip-type transmission element, in particular a coil spring. This enables a particularly space-saving and part-saving design.

As a result, for example, in an electrical transmission device in a motor vehicle designed in accordance with the invention as a coil spring arrangement, the coil spring can be accommodated at least partially directly by the steering wheel and/or by a component or assembly on the vehicle structure side instead of in a separate coil spring housing in the form of a coil spring cassette, i.e., without a separate housing in the form of a coil spring cassette completely accommodating the coil spring.

Preferably, an associated receiving space for the strip-type transmission element can be closed in each case with a separate cover similar to a housing cover or by at least one further housing part, so that the strip-type transmission element is as completely enclosed as possible as a result, as is usual and known for coil springs in the prior art, in order to enable the safest and most stable spiralled winding possible.

The strip-type transmission element is preferably arranged in the at least one housing part or accommodated thereby in such a way that, when the components connected to the transmission element or the assemblies connected to the transmission element move relative, to one another, the transmission element can unwind and/or wind up as required to compensate for the relative movement.

In a further advantageous embodiment of an electrical transmission device according to the present invention, at least one electrical discharge device, in a functional installation state in a motor vehicle, is designed and configured to be electrically connected to a defined protective potential, in particular to ground, so that, in a functional installation state of the electrical transmission device in a motor vehicle, an electrostatic charge of the electrical transmission device, in particular of the strip-type transmission element and/or at least one housing part, can be dissipated at least partially, preferably completely, via at least one electrical discharge device to a defined protective potential, in particular to ground.

At least one electrical discharge device can therefore, in addition to the electrical connection to the electrical transmission element and/or the at least one housing part, also be electrically connected to, in particular contacted with a defined (electrical) protective potential, preferably an electrical ground potential (GND), so that the electrical discharge device can discharge electrostatic charges, in particular to a protective potential, preferably ground (GND).

In the present context, an electrical ground means an electrical reference potential, preferably provided by a conductive body which is electrically grounded and of which the electrical potential is therefore preferably zero volts or which is connected to a defined electrical potential. Said electrical potential of the ground can be referred to as the ground potential. For this purpose, the electrical ground can preferably be connected to the conductive ground via one or more suitable electrical conductors, and thus can be grounded. Alternatively, however, the electrical ground in a vehicle typically corresponds to the zero potential of the power supply in the vehicle, wherein the vehicle body is connected to the zero potential and thus forms the electrical ground. Optionally, it may be necessary to resort to a protective potential with a non-zero electrical potential as the reference potential or electrical ground.

The dissipation of electrostatic charges, which can occur, for example in a functional installation state of the electrical transmission device in a motor vehicle (whether in the region of the strip-type electrical transmission element or in the region of a housing part), to a defined protective potential, preferably to ground, enables a defined and controlled dissipation of the charge in a simple manner and thus a defined and controlled and above all steady discharge. The dissipation to ground is particularly easy to implement because the vehicle structure, in particular the vehicle body, already provides an electrical ground anyway. In particular, the vehicle body can be used directly to dissipate electrostatic charges without necessarily having to use additional components with defined protective potentials. All that needs to be done is to ensure appropriate and, above all, sufficient electrical contact with this body.

In a further advantageous embodiment of an electrical transmission device according to the present invention, the strip-type electrical transmission element has a first strip end, in particular on the vehicle structure side, with a first connection region, in particular on the vehicle structure side, and a second strip end, in particular on the steering input side, with a second connection region, in particular on the steering input side, wherein it is possible to establish an electrical connection, preferably via at least part of the first connection region, to a component arranged on the vehicle structure side and/or to an assembly arranged on the vehicle structure side, and wherein it is possible to establish an electrical connection, in particular via at least part of the second connection region, to a component arranged on the steering input side, in particular on the steering wheel side, and/or to an assembly arranged on the steering input side, wherein at least one discharge device is electrically connected to, in particular electrically contacted with the electrical transmission element at least via part of the first connection region, in particular via at least that part of the first connection region via which an electrical connection can be established to the associated component and/or the assembly, or at least via a part of the second connection region, in particular via at least that part of the second connection region via which an electrical connection can be established to the associated component and/or the assembly, so that, in a functional installation state of the electrical transmission device in a motor vehicle, an electrostatic charge of the electrical transmission device can be dissipated at least partially, in particular completely, at least via the associated part of the first connection region or at least via the associated part of the second connection region and at least one discharge device.

In this context, a “strip end” does not necessarily mean a “sharp” or “edge-like” end. Rather, a strip end is an end region of one or more conductor track(s) running along the strip, but equally also the end of a carrier material surrounding at least one conductor track or the end of a strip jacket. The conductor tracks of the electrical transmission element can have different lengths. In such a design, the conductor tracks do not necessarily have to be, but may be flush in the region of the strip ends. Consequently, a strip end also includes a length portion of the strip in which at least one conductor track ends.

An embodiment of an electrical transmission device according to the invention in which at least one discharge device is connected to the electrical transmission element at least via that part of the first and/or second connection region via which the electrical connection to the component on the vehicle structure side and/or the assembly on the vehicle structure side or the component on the steering body side and/or the assembly on the steering body side can also be established has proven to be particularly advantageous, since this can prevent the transmission of electrostatic charges to components and/or assemblies which are electrically connected directly to the particular connection region, i.e., to components and/or assemblies which in particular are electrically contacted directly with the particular connection region. An arrangement of the at least one discharge device in the region of the first and/or second connection region is furthermore advantageous for assembly reasons as well as with regard to maintenance purposes, since these regions are easily accessible, even in a functional installation state of the electrical transmission device in a motor vehicle, for example for repair or replacement of the discharge device(s). It is also relatively easy to arrange discharge devices in the first and/or second connection region when producing or manufacturing an electrical transmission device according to the invention.

If the discharge device is arranged in or on the connection region on the vehicle structure side, it is advantageous that discharge takes place even if the steering wheel is not grounded or its grounding has been lost. If the discharge device is arranged in or on the connection region on the steering wheel side and the steering wheel is grounded, dissipation can take place on the steering wheel side even if the winding strip or the electrical transmission device has been torn off. Therefore, an arrangement of discharge devices on both sides can also be expedient in order to combine both advantages.

Alternatively or additionally, in a functional installation state of the electrical transmission device in the motor vehicle, the strip-type electrical transmission element can be at least partially electrically connected to, in particular electrically contacted with at least one electrical discharge device via a middle strip region located between the first and second connection regions. It can thus be achieved that, in particular in a functional installation state of the electrical transmission device in a motor vehicle, an electrostatic charge of the electrical transmission device can be dissipated at least partially, in particular completely, alternatively or additionally via the middle strip region located between the first and second connection region and the at least one discharge device electrically connected thereto. The electrical connection or contacting of a plurality of connection regions of the strip-type electrical transmission element with at least one discharge device in each case can lead to a particularly high robustness of the electrical transmission device with respect to electrostatic charges. An electrical discharge device arranged in the first and/or second connection region and/or middle strip region of the strip-type electrical connection element can also preferably be electrically connected to or electrically contacted with an electrical protective potential, in particular a ground potential.

Despite the fundamental possibility of arranging at least one electrical discharge device also in a middle strip region of the strip-type electrical transmission element lying between the first and second connection region, an arrangement in the region of the first and/or second strip end, in particular the first and/or second connection region, preferably in that part of the second connection region via which an electrical connection can be established with the component arranged on the steering input side, in particular on the steering wheel side, and/or the assembly arranged on the steering input side, is particularly advantageous in many cases. This is because it can be ensured that, for example in the event of a line break in the electrical transmission element, a portion of the electrical transmission device electrically connected to the component arranged on the steering input side, in particular on the steering wheel side, and/or the assembly is nevertheless grounded via at least one electrical discharge device, so that any electrostatic charges can also be dissipated in such a case. As a result, the robustness and operational reliability of an electrical transmission device according to the invention can be further increased.

In a further advantageous embodiment of an electrical transmission device according to the present invention, the strip-type electrical transmission element has at least one conductor track having a first conductor track end and a second conductor track end, wherein the conductor track preferably extends from the first strip end to the second strip end, wherein in particular an end region at the first conductor track end and at the second conductor track end in each case forms part of the associated connection region of the strip-type transmission element, wherein at least one discharge device is electrically connected to, in particular electrically contacted with the electrical transmission element via a first conductor track end or a second conductor track end, so that, in a functional installation state of the electrical transmission device in a motor vehicle, an electrostatic charge of the electrical transmission device can be dissipated, at least partially, preferably completely, via at least one conductor track, in particular via the first conductor track end or second conductor track end thereof, and at least one discharge device.

In the sense of the present invention, a “conductor track” is understood to mean an electrical conductor, in particular a wire-like electrical conductor or an electrical conductor made from a wire, or a metal strip, a flat wire or a metal foil, in particular made from an electrically conductive, metallic material such as copper or a copper alloy, which preferably extends from the first strip end of the electrical transmission element to the second strip end of the electrical transmission element. A conductor track can be composed of a plurality of portions which are electrically connected to one another, in particular contacted with one another, via suitable electrical connection means. For the purposes of the present invention, a “conductor track” is understood to mean in particular a flexible, bendable and windable conductor. An advantageous embodiment of such a conductor track can, for example, be an embodiment made of a copper fabric or, alternatively, a copper wire. Conductor tracks, in particular conductor tracks made of metallic materials, can be contacted electrically particularly easily, for example via soldered connections. Accordingly, the at least one conductor track in the region of the first and/or second conductor track end (of course also in a portion lying between the first conductor track end and second conductor track end) can be connected to or contacted with the at least one electrical discharge device of an electrical transmission device according to the invention in a particularly simple manner. In particular, an attachment, in particular an electrical contacting with at least one electrical discharge device in the region of the first and/or second conductor track end of at least one conductor track is possible in a relatively simple manner. This is because the first and/or second conductor track end of the at least one conductor track is located in the first or second connection region of the first or second strip end, respectively.

In a further advantageous embodiment of an electrical transmission device according to the present invention, the electrical transmission device further comprises at least one electrical connection device electrically connected to the strip-type transmission element, in particular contacted with the latter, in particular at least one plug device, preferably at least one connection device on the steering input side, in particular at least one plug device on the steering input side, via which the electrical transmission element can be electrically connected to a component and/or an assembly, in particular to a component on the steering input side and/or an assembly on the steering input side, wherein the connection device is preferably electrically connected to, in particular contacted with the strip-type transmission element via the particular connection region of the strip end facing the connection device.

If the connection device is in particular a plug device, in particular a connection device on the steering input side, in particular a plug device, in a particularly advantageous embodiment this device is preferably electrically connected to, in particular electrically contacted with the strip-type electrical transmission element via the second connection region of the second strip end facing the connection device on the steering input side. The contacting can be formed via a soldered connection, a clamp connection or solely by a, in particular detachable, plug-in connection and thus solely by material contact between the connection device on the steering input side and the second connection region of the second strip end. In particular, at least one second conductor track end of at least one conductor track associated with the strip-type electrical transmission element can be electrically connected to, in particular contacted with the connection device on the steering input side. For this purpose, the connection device on the steering input side can in particular have at least one contact element, preferably at least one electrically conductive contact pin (for example made of a metallic material), preferably a plurality of contact elements, in particular a plurality of contact pins, wherein each conductor track of the strip-type electrical transmission element preferably is electrically connected or connectable to, in particular electrically contacted or contactable with one of the contact elements, in particular to precisely one contact pin in each case.

Similarly, at least one connection device, in particular at least one plug device, can be a connection device on the vehicle structure side, in particular a plug device on the vehicle structure side. This is preferably electrically connected or connectable to, in particular electrically contacted or contactable with the strip-type electrical transmission element via the first connection region of the first strip end facing the connection device on the vehicle structure side. Here, too, the contacting can take place via a soldered connection, a clamp connection or solely by a plug-in connection between the connection device on the vehicle structure side and the first connection region of the first strip end. In particular, at least one first conductor track end of at least one conductor track associated with the strip-type electrical transmission element can be electrically connected or connectable to, in particular contacted or contactable with the connection device on the vehicle structure side. For this purpose, the connection device on the vehicle structure side, in particular in the case of a plug device on the vehicle structure side, preferably has at least one contact element, in particular at least one contact pin (for example made of a metallic material), preferably a plurality of contact elements, in particular contact pins, wherein each conductor track of the strip-type electrical transmission element is preferably electrically connected or connectable to, in particular electrically contacted or contactable with one of the contact elements, in particular in each case with a contact pin.

Connecting the electrical transmission element via plug devices of this type on the steering input side and/or on the vehicle structure side can considerably simplify the assembly of the electrical transmission device, because plug connections can generally be implemented by simply plugging the associated components together. Accordingly, such a connection technique not only reduces the assembly effort, but also the assembly costs. Also, plug-in connections can be used to achieve a reliable and reproducible connection between the components and/or assemblies to be connected via the electrical transmission device. Furthermore, plug-in connections can be designed in a simple manner as detachable connections, in contrast to soldered connections and adhesive connections, for example.

In a further advantageous embodiment of an electrical transmission device according to the present invention, the at least one connection device, in particular the at least one plug device, comprises at least one protective potential contact element, preferably at least one protective potential contact pin, in particular at least one ground pin, wherein the at least one protective potential contact element, in a functional installation state in a motor vehicle, is designed and configured to be electrically connected to a defined protective potential, in particular to ground, wherein at least one electrical discharge device of the transmission device is electrically connected to, in particular contacted with the at least one protective potential contact element in such a way that, in a functional installation state of the electrical transmission device in a motor vehicle, i.e., when the protective potential contact element is electrically connected to a defined protective potential, for example to a ground potential, an electrostatic charge of the electrical transmission device can be dissipated at least partially, preferably completely, via the discharge device and the associated protection potential contact element to the defined protective potential, in particular to ground.

By directly implementing or integrating at least one protective potential contact element, preferably at least one protective potential contact pin, in particular at least one ground pin, in at least one connection device, in particular in at least one plug device, at least one electrical discharge device connected to, in particular contacted with the strip-type electrical connection element in the first or second connection region can be electrically connected to a protective potential in a particularly simple and practical manner. This avoids the formation of complex dissipation paths and, if necessary, the need to form suitable openings for the passage of protective potential contact elements in a housing which at least partially accommodates the strip-type electrical transmission element. In addition, such an embodiment ensures that electrostatic charges can be dissipated in the region of the at least one connection device, in particular plug device, even in the event of a line break in the strip-type electrical connection element.

In a further advantageous embodiment of an electrical transmission device according to the present invention, at least one connection device, in particular at least one plug device, is formed in multiple parts, wherein the connection device preferably has a first connection portion, in particular a plug element, arranged facing the transmission element, and a second connection portion, in particular a plug collar, arranged facing the associated component that can be connected via the connection device and/or facing the assembly, wherein the first connection portion and the second connection portion are preferably electrically connected to one another, in particular via at least one contact element, in particular via at least one contact pin, wherein at least one contact element or at least one contact pin is preferably electrically connected to the first connection portion or to the second connection portion, respectively, of the strip-type electrical transmission element, in particular to a first conductor track end or a second conductor track end, respectively, of the at least one conductor track and either directly or via at least one electrical discharge device, wherein the conductor track ends are particularly preferably also electrically connected to the first connection portion, i.e., the plug element, or are arranged at least partially within the latter and/or terminate within the latter.

A two-part design of the at least one connection device or of the connection device arranged on the steering input side and/or of the connection device arranged on the vehicle structure side can be advantageous for the arrangement or assembly of the electrical transmission device. A design of the first connection portion belonging to a particular connection device, in particular therefore of the plug element, separately from the second connection portion, in particular the plug collar, enables a more flexible design and arrangement in an electrical transmission device according to the invention, in particular if the latter has at least one housing part. As a result, for example, as is also the case in a particularly advantageous embodiment of an electrical transmission device according to the present invention, the first connection portion, that is to say the plug element, can be arranged almost entirely within the housing, in particular together with and in the immediate vicinity of at least one strip end of the electrical transmission element, while the second connection portion, that is to say the plug collar, can be inserted, for example, into an opening in the housing in such a way that the second connection portion protrudes at least partially out of the housing in order to make a plug-in connection to a matching mating connection portion, in particular a matching mating plug.

At the same time, a connection, in particular both a mechanical connection and an electrical connection, can be established between the first connection portion and the second connection portion, i.e., between the plug element and the plug collar, in a simple manner, for example by means of a simple plug-in connection, wherein the first connection portion and the second connection portion are preferably plugged into one another via at least one contact element, in particular via at least one contact pin, and in particular are electrically connected to one another via at least one contact element, in particular via at least one contact pin. Particularly preferably, at least one contact element, which protrudes from the first connection portion and which is preferably connected to a conductor track of the electrical transmission element either directly or via at least one electrical discharge device, pierces a base of the second connection portion, wherein the contact element is thus particularly preferably placed in contact with the second connection portion in such a way that an electrical connection is established between the piercing contact element and the second connection portion, in particular the base thereof.

In this context, it is possible in principle to arrange at least one electrical discharge device in the region of the first and/or second connection portion of a particular connection device, which discharge device is in particular electrically connected to the strip-type electrical transmission element and in particular can be electrically connected indirectly or directly to a protective potential, in particular ground, for example via a corresponding contact element provided in particular for this purpose. By arranging at least one electrical discharge device in the region of the first and/or second connection portion of a particular connection device, on the one hand a particularly space-saving design of an electrical transmission device according to the invention can be achieved. On the other hand, the risk of passing on an electrostatic charge of the transmission device to neighboring assemblies can be considerably reduced in a simple manner. This is because, even in the event of a break of the electrical transmission element or in the event of a loosening of the connection between the first and the second connection portion, i.e., between the plug element and plug collar, of a particular connection device, reliable dissipation of electrostatic charges is ensured via the at least one electrical discharge device arranged in the region of the first and/or the second connection portion. The discharge device can be provided not only in the region of the vehicle-side plug collar and/or steering-wheel-side plug collar of the coil spring cassette, but also alternatively or additionally in the respective plug elements.

In a further advantageous embodiment of an electrical transmission device according to the present invention, at least one discharge device comprises at least one electronic component, preferably an SMD component or a wired component, in particular an ohmic resistor, in particular a high-resistance ohmic resistor, an RC combination in the form of a parallel circuit formed of a resistor and a capacitor, a varistor, a leakage diode or a Zener diode, i.e., a so-called Z diode, and/or a glow discharge gap and/or a spark gap, or a combination thereof.

An “electronic component” in the sense of the present invention is preferably a discrete component, such as one of the above.

An “SMD component” in the sense of the present invention is a surface-mountable component, as already expressed by the acronym SMD (Surface-Mounted Device). Electronic SMD components usually do not have wire connections, but can be directly connected to a connection partner by means of solderable connection faces (usually via a soldered connection).

Wired components, on the other hand, have one or more wire portions for electrical contacting (for example via a soldered connection).

A “varistor”, or VDR (“Voltage Dependent Resistor”), is understood in the present case to mean an electronic component that has a resistance dependent on the electrical voltage. Above a certain voltage, which is typical for the particular varistor, the differential resistance of this component abruptly decreases. Varistors are ideally suited for use in overvoltade protection, in particular also for dissipating electrostatic charges.

A “leakage diode” in the present case is understood to mean a semiconductor component that can also be used to dissipate overvoltages or electrostatic charges. These components are also referred to as suppressor diodes or TransZorb diodes, which act like bidirectional Z-diodes to dissipate overvoltages. The mode of operation is generally known to a person skilled in the art from the prior art, to which reference is hereby expressly made for more detailed information in this respect.

A “Zener diode (Z-diode)” is understood in the present case to mean a semiconductor diode which, when used in an electrical transmission device according to the invention, is operated as part of a discharge device or as a discharge device, in particular in the reverse direction. In the reverse direction, the so-called Zener or avalanche effect occurs in a silicon diode, in which case the current increases abruptly above a certain reverse voltage (breakdown voltage). In the forward direction, the Z-diode operates like a normal diode.

Glow discharge gaps or spark gaps are also generally known to a person skilled in the art from the prior art and can serve as electronic components for an electrical discharge device within the scope of the present invention.

A spark gap in the sense of the present invention is preferably made up of two conductors (electrodes) and a discharge space between them, wherein a gas (for example air) is located in the discharge space. If the voltage between the two electrodes rises to a flashover voltage value, the resulting electric field causes an ionization of the gas in the discharge space, the gas becomes conductive, and the gap is short-circuited by a spark within fractions of a microsecond due to the impact ionization.

A dissipation of electrostatic charges or voltages by means of a gas discharge can also be carried out in a particularly preferred manner in the case of a glow discharge gap in the sense of the present invention.

In an advantageous embodiment of a transmission device according to the invention, the electronic component can be soldered to a first conductor track end and a second conductor track end, respectively, in particular in the first or second connection region of the strip-type electrical transmission element. Alternatively, such an electronic component can also be electrically contacted with the strip-type electrical transmission element at other points of the electrical transmission device, for example in a middle portion of the strip-type electrical transmission element lying between the first and second connection regions, also in the region of the plug element or plug collar of a particular connection device.

At the same time, the electronic component can also be electrically connected to a protective potential, in particular to a ground potential, wherein to this end the electronic component can be soldered to a component providing the protective potential, for example.

The advantage of using a discrete electronic component in a discharge device or as a discharge device is the high flexibility with regard to possible arrangement variants. Such components, depending on their type, are very small and can therefore be arranged almost at any position of the electrical transmission device within the latter, as long as in each case a direct or indirect (i.e., via a further connection element) electrical connection to the strip-type electrical transmission element and/or a corresponding connection device and/or a desired protective potential can be realized.

In a further advantageous embodiment of an electrical transmission device according to the present invention, at least one discharge device, in particular at least one electronic component of the discharge device, is integrated at least partially, preferably completely into the connection device, preferably into the first connection portion. By integrating at least one discharge device into the connection device, on the one hand a very space-saving electrical transmission device can be provided.

On the other hand, the robustness of a system with an electrical transmission device, in particular a corresponding system for a motor vehicle, can be increased, especially in a functional installation state in a motor vehicle. This is because, even in the event of line breaks in the region of the electrical transmission element, in particular in the event of damage to the latter, a reliable, in particular steady dissipation of electrostatic charges present in the region of the connection device is ensured.

Alternatively or additionally, an additional conductor, preferably a copper conductor track, can be incorporated in the winding strip or in the electrical transmission element and serves specifically to dissipate electrostatic charges generated in or on the winding strip. For this purpose, this conductor is preferably connected to the ground potential on the steering wheel side, to where the charges can be dissipated. Alternatively, the conductor can also be connected to the ground potential on the vehicle structure side or to both ground potentials simultaneously. A plurality of such conductors can also be used in a plurality of winding strips. Furthermore, this conductor can also simultaneously be the supply conductor, for example for the ground supply of control units arranged on the steering wheel side.

As already described, the connection device composed of the first and second connection portions in this case is preferably electrically connected to, in particular contacted with the strip-type transmission element via the particular connection region of the strip end facing the connection device.

As also mentioned above, the first connection portion of a particular connection device (such a connection device can be arranged both in the region of the steering-input-side strip end of the strip-type electrical transmission element and in the region of the vehicle-structure-side strip end of the strip-type electrical transmission element) can be a plug element. The first connection portion, in particular the plug element, in this case can be connected to, in particular contacted with at least part of a connection region (of the first or second) of the strip-type electrical transmission element. As described above, at least a part of the first and/or second connection region can be formed in particular by an end region at a first conductor track end and at a second conductor track end of the at least one conductor track of the strip-type electrical transmission element. Accordingly, at least one discharge device can be arranged in the particular connection region at the first conductor track end and/or second conductor track end and can be contacted there. Furthermore, the at least one discharge device can be electrically connected to, in particular contacted with the first connection portion, in particular the plug element. Thus, an electrical discharge device configured as an electronic component can, for example, contact both a conductor track end and the first connection portion. Furthermore, the first connection portion as such can at least partially form the electrical discharge device. In this case, a conductor track end of the at least one conductor track can be electrically connected to, in particular contacted with the first connection portion, in particular the plug element.

In a further advantageous embodiment of an electrical transmission device according to the present invention, at least one discharge device is formed at least partially, preferably completely, by the connection device itself, in particular by the first connection portion and/or the second connection portion of the connection device, wherein the connection device, in particular the associated connection portion, is preferably made of a suitable material and/or has a suitable coating which enables electrical discharge of an electrical charge.

Such a design can be advantageous because—in contrast to a design of the at least one discharge device in the form of electronic components—the functionality of the discharge device is independent of the quality of the soldered joints contacting the electronic components. In the case of a direct design of the first and/or second connection portion as an electrical discharge device, damage or impairment of soldered joints may indeed also occur—for example between the conductor track ends and the first connection portion of the connection device—however, sufficient functionality of the discharge device can nevertheless be ensured by the design of the electrical discharge device by means of the material or a coating of the connection device. Furthermore, the direct design of the connection device, i.e., of the first and/or second connection portion, as an electrical discharge device is associated with a reduced assembly effort, and the soldering of individual electronic components is not necessary in this case. It is even conceivable to have an embodiment in which the first or second connection region of the strip-type electrical transmission element is electrically connected to the connection device without a soldered connection, for example via a plug-in contact between the first connection portion and the particular connection region. In such a case, the forming of soldered joints with respect to the arrangement of the electrical discharge device can be dispensed with entirely. Such an embodiment can further increase the operational reliability for the use of the electrical transmission device. In addition, other discharge characteristics can be realized, in particular adjusted in a targeted manner, which will be explained in more detail later.

A discharge device formed at least in part by the connection device itself can, for example, be electrically connected to, in particular contacted with the particular (first or second) connection region of the strip-type electrical transmission element, namely in particular via the first connection portion of the connection device. In particular, the electrical connection or contacting can be formed by an electrical connection or contacting of the first connection portion to/with a region of a first conductor track end or second conductor track end, respectively.

In a further advantageous embodiment of an electrical transmission device according to the present invention, the connection device is at least partially accommodated by the housing part, wherein the connection device is preferably accommodated in the housing part and electrically connected to, in particular contacted with the housing part, in particular if at least one discharge device is formed at least partially by a connection device, in such a way that an electrical charge of the housing part can be dissipated via the connection device.

When the electrical transmission device according to the invention is used, in particular when used in a functional installation state in a motor vehicle (for example while driving), electrostatic charges may arise not only in the region of the strip-type electrical transmission element, but also at said housing part, in which the strip-type electrical transmission element can be at least partially accommodated. Accordingly, it is of particular advantage if electrostatic charges of the housing part can be dissipated via the connection device without having to arrange additional discharge devices on the housing part.

In a further embodiment of an electrical transmission device according to the present invention, the connection device is accommodated by the housing part in such a way that the connection device can be electrically connected to, in particular contacted, alternatively or additionally with a further housing part, so that the connection device is electrically connected to, in particular contacted with the further housing part in a functional installation state of the electrical transmission device in a motor vehicle, in such a way that an electrical charge of the further housing part can be dissipated via the connection device. Such a design is particularly advantageous in the case of a multi-part, in particular two-part, design of a housing which at least partially accommodates the strip-type electrical transmission element. This is because electrostatic charges can occur on all housing parts of such a housing. Here, too, no additional discharge devices (for example in the form of electronic components) need to be arranged in the event of an electrical connection, in particular contacting, of the further housing part to/with the connection device providing the electrical discharge device. The manufacturing effort and the manufacturing costs of an electrical transmission device according to the invention are thus inherently reduced, with a simultaneous increase in operational reliability with regard to the dissipation of electrostatic charges.

Preferably, the electrostatic charge is dissipated via the connection device via the particular plug collar to the corresponding plug element, which are each made of dissipative material or are coated therewith. The dissipation could, for example, continue to a ground-conducting steering wheel, which is electrically connected to the plug element.

According to a further embodiment of an electrical transmission device according to the invention, preferably the first connection portion, in particular the plug element, is accommodated by the at least one housing part together with the strip-type transmission element.

In this way, a transmission device with a discharge device based on an electronic component, in particular a resistive discharge device, and a discharge device formed by the first connection portion (in particular the plug element), in particular a non-resistive discharge device, can be provided in a particularly simple manner. With such an embodiment, a dissipation based on a resistive discharge device can be combined with a dissipation based on a non-resistive discharge device. Thus, reliable dissipation of electrostatic charges in different voltage ranges can be ensured.

In a further advantageous embodiment of an electrical transmission device according to the present invention, at least one discharge device is designed, in particular with regard to its electrical conductivity and/or its specific electrical resistance, in such a way that, in a functional installation state of the electrical transmission device in a motor vehicle, a signal and/or energy transmission, for example a supply with an electrical useful voltage, to a component electrically connected to the strip-type transmission element and/or to an assembly, in particular to a component arranged on the steering input side and/or to an assembly arranged on the steering input side, is at least substantially not impaired, preferably not at all, wherein electrostatic charges can be dissipated at least to the extent that undesirable influence on and/or damage to the component electrically connected to the strip-type transmission element and/or to the assembly is avoided.

The at least one discharge device can thus be configured to dissipate, in particular, only those voltages (or electrostatic charges) which are above the useful voltage of a component (for example an airbag) connected to the electrical transmission element. The expression “substantially not impaired” it is to be understood in the context of the present invention or with reference to the stated embodiment to mean that the signal and/or energy transmission via the electrical transmission device with respect to a component and/or assembly (for example an airbag) electrically connected to the strip-type transmission element is impaired only slightly, if at all, in particular only to such an extent that a signal and/or energy transmission is ensured in a sufficient manner.

In a further advantageous embodiment of an electrical transmission device according to the present invention, at least one discharge device is resistive, i.e., it has a substantially constant electrical resistance, wherein the at least one resistive discharge device preferably has a resistance of at least 0.1 MΩ, 0.5 MΩ, 0.8 MΩ or 0.9 MΩ and at most of 1 MΩ, 1.1 MΩ, 1.2 MΩ or of at most 100 MΩ. In this regard, the resistance value can be adapted to the specific conditions present in respect of different uses of the electrical transmission device. For example, in the case of use in motor vehicles, different types of motor vehicles may require different resistance values to ensure reliable dissipation of electrostatic charges. In the case of resistive discharge devices, the resistance value is particularly preferably selected in such a way that electrostatic charges are dissipated, but the transmission, via the electrical transmission device, of useful signals or of a useful voltage of a component and/or an assembly connected to the electrical transmission element is not impaired. It has been shown that it is of particular advantage in this respect if the resistance has a value of substantially 1 MΩ.

In particular, it can be advantageous in an electrical transmission device according to the invention if in particular a discharge device is resistive, which in particular comprises at least one electronic component or consists of one or more electronic components. By designing the discharge device in the form of a resistive electronic component, a dissipation of electrostatic charges based on an ohmic resistance can be realized at different positions of the transmission device according to the invention, because electronic components generally require only a small amount of space and can be attached at any desired positions.

In a further advantageous embodiment of an electrical transmission device according to the present invention, at least one discharge device is at least partially non-resistive, preferably completely non-resistive, i.e., it has a variable electrical resistance, wherein the discharge device preferably has an at least partially voltage-dependent electrical resistance, i.e., it preferably has a voltage-dependent resistance behavior, i.e., its electrical resistance is preferably dependent on an applied voltage, wherein the discharge device is in particular designed and configured in such a way that
it has a high resistance in the presence of a voltage below a defined voltage limit value, i.e., up to a predetermined voltage level, for example a nominal voltage level of a useful voltage of the component arranged on the steering input side and/or the assembly, and
it has a low electrical resistance in the presence of a voltage above the defined voltage limit value, i.e., above the specified voltage level.

In such an embodiment, the resistance of the electrical discharge device adapts as a function of the voltage present. In the case of a voltage present that exceeds a defined voltage limit value, the discharge device has a low electrical resistance in particular, which is why voltages can be dissipated via the discharge device. In the case of a voltage that is below a defined voltage limit, the electrical discharge device has a high resistance, which prevents the voltage (which is below the voltage limit value in a range that is not critical for a component connected to the electrical transmission device) from being dissipated. As previously mentioned, it can be advantageous if the transmission device according to the invention comprises at least one discharge device which is at least partially, preferably entirely, formed by the connection device itself, and is at least partially non-resistive. With regard to the advantages in this respect, reference is made to the preceding description.

In an alternative embodiment, the discharge device can at least partially have a current-dependent electrical resistance, i.e., its electrical resistance is preferably dependent on an electric current present, wherein the discharge device is in particular designed and configured in such a way that
it has a high resistance in the presence of a current below a defined current limit value, i.e., up to a predetermined current level, for example a nominal current level of a useful current of the component arranged on the steering input side and/or of the assembly, and
it has a low electrical resistance in the presence of a current above the defined current limit value, i.e., above the specified current level.

In a further advantageous embodiment of an electrical transmission device according to the present invention, the transmission device comprises at least one resistive discharge device and at least one non-resistive discharge device, wherein the at least one resistive discharge device comprises at least one electronic component or consists of at least one electronic component, and wherein the at least one non-resistive discharge device is at least partially formed by at least one connection device, in particular by a connection device on the steering input side, which connection device is made of a material and/or has a coating which is selected in such a way that the connection device, at least in portions, has a high resistance in the presence of a voltage below a defined voltage limit value, i.e., up to a predetermined voltage limit value, for example a nominal voltage level of a useful voltage of the component arranged on the steering input side and/or of the assembly, and has a low electrical resistance in the presence of a voltage above the defined voltage limit value, i.e., above the predetermined voltage level. Advantages in this respect have already been described above, and reference is therefore made fundamentally to the preceding description of advantages It should be mentioned, however, that with such a combined arrangement of resistive as well as non-resistive discharge devices in a transmission device according to the invention, a wide voltage range of possible overvoltage values of electrostatic charges can be covered. Furthermore, with such a combination of differently designed discharge devices, it is possible to arrange the discharge devices at a multitude of positions of the electrical transmission device, in particular at the strip-type electrical transmission element, the connection device and/or a housing part or housing. This makes it possible to increase the redundancy of the discharge devices on the electrical transmission device, and the same applies for the reliability in the dissipation of overvoltages or electrostatic charges. This is accompanied by an improvement in the functional reliability of components and/or assemblies connected to the electrical transmission device.

As mentioned at the outset, the object addressed by the present invention is also achieved via a motor vehicle comprising an electrical transmission device.

A motor vehicle according to the invention comprising an electrical transmission device is distinguished in that it has an electrical transmission device according to the invention. In particular, a motor vehicle according to the invention can be a motor vehicle comprising a component on the vehicle structure side and/or an assembly on the vehicle structure side as well as a component on the steering input side and/or an assembly on the steering input side, which are each electrically connected to one another via the electrical transmission device according to the invention. The invention can be used in motor vehicles, such as passenger cars, commercial vehicles such as trucks, motor vehicles for passenger transportation (buses), and agricultural and construction vehicles, wherein a motor vehicle according to the invention can be in particular such a vehicle. Likewise, an analogous use of an electrical transmission device according to the invention is conceivable in an aircraft or a ship.

The preferred embodiments presented with reference to the electrical transmission device and their advantages also apply accordingly for a motor vehicle according to the invention, even if they are not explained again separately with reference to the motor vehicle, and vice versa.

Further features of the invention arise from the claims, the figures and the description of the figures. All of the features and combinations of features that are cited in the description above, and also the features and combinations of features that are cited in the description of the figures below and/or as shown in the figures alone, can be used not only in the combination indicated in each case, but also in other combinations or on their own.

The invention will now be explained in more detail on the basis of a preferred exemplary embodiment and with reference to the accompanying figures. In the figures:

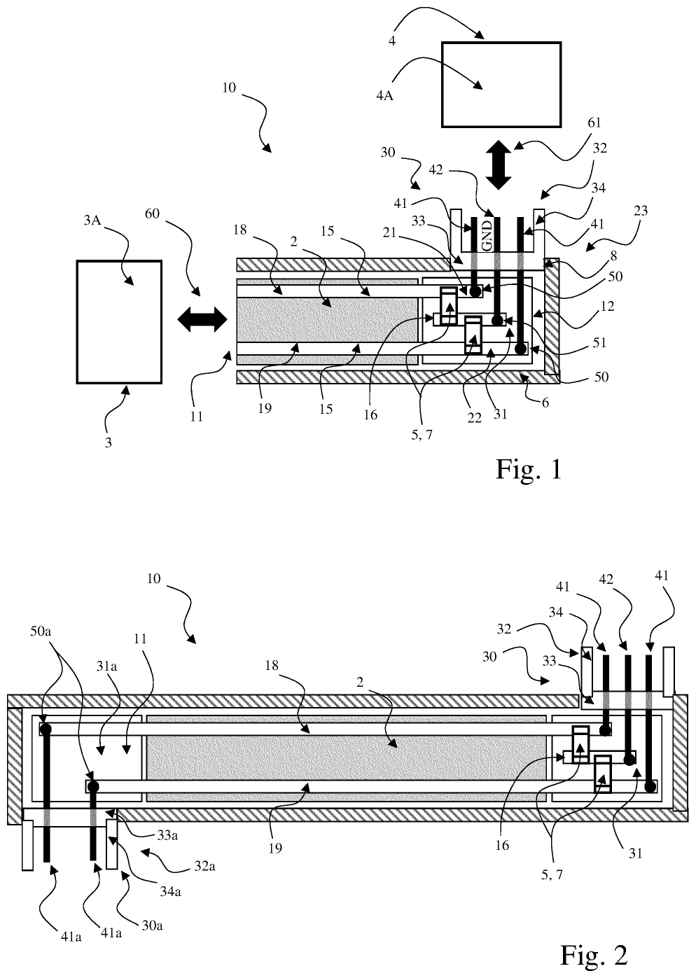

FIG. 1 shows a section through a schematic view of a detail of an electrical transmission device according to an exemplary embodiment of the present invention,

FIG. 2 shows a section through a schematic view of an electrical transmission device according to an exemplary embodiment of the present invention with a connection device on the vehicle structure side and a connection device on the steering wheel side, and

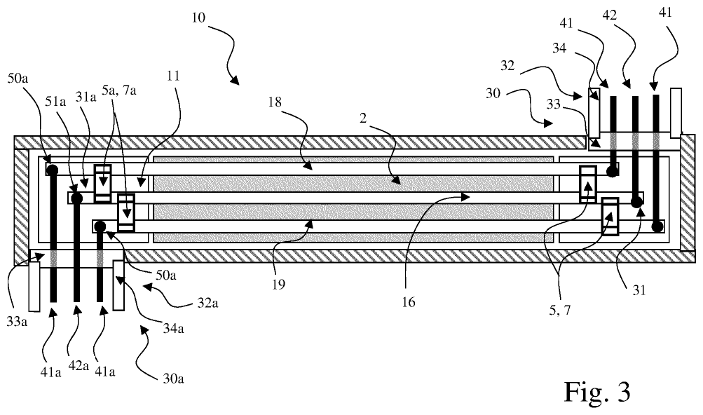

FIG. 3 shows a section through a schematic view of an electrical transmission device according to an exemplary embodiment of the present invention with a connection device on the vehicle structure side and a connection device on the steering wheel side, and discharge devices on the vehicle structure side and steering wheel side.

FIG. 1 shows a schematic view of a detail of a section through an exemplary embodiment of an electrical transmission device 10 according to the invention. The electrical transmission device 10 shown here is a coil spring arrangement 10 for a motor vehicle (not shown).

In the electrical transmission device 10 shown here in the motor vehicle, the strip-type electrical transmission element 2 (i.e., the coil spring) forms an electrical connection between a component 3A arranged on the vehicle structure side and a component 4A arranged on the steering input side, in particular on the steering wheel side, wherein the components 3A and 4A are each parts of an associated assembly 3 and 4, respectively. The electrical connection is illustrated in each case by the reversible direction arrows 60, 61 filled in black.

The component 4A arranged on the steering wheel side or the assembly 4 is an airbag 4A or an airbag assembly 4, which is connected via the electrical transmission device 10 to an associated control unit 3A arranged on the vehicle structure side, in this case a corresponding airbag control unit 3A, as a component 3A on the vehicle structure side and part of the assembly 3. The electrical transmission device 10 thereby establishes an electrical connection for energy transmission and signal transmission (for example in the form of voltage transmission) between the component 3A on the vehicle structure side or the assembly 3 on the vehicle structure side and the component 4a on the steering input side or the assembly 4 on the steering input side.

In accordance with the invention, this exemplary embodiment of an electrical transmission device 10 comprises a strip-type electrical transmission element 2 in the form of a winding strip or a coil spring 2 and, in accordance with the invention, a plurality of discharge devices 5, 7, 31, 33 and 34, which will be described in more detail later and which are each designed to dissipate an electrostatic charge of the electrical transmission device, wherein the discharge devices 5, 31, 33 and 34 are each electrically connected to, in particular electrically contacted with the strip-type electrical transmission element 2 and are designed and configured in such a way that an electrostatic charge of the electrical transmission device 10 can be dissipated in each case via the electrical discharge devices 5, 7, 31, 33 and 34. The dissipation is achieved here in particular by a discharge of an overvoltage generated by electrostatic charge on the conductor tracks 18 and 19 via the discharge devices 5, 7, 31, 33 and 34 to ground (GND).

The electrical transmission element 2 formed as a winding strip or coil spring 2 is a spirally wound cable 2, in particular a ribbon cable 2, which is accommodated by a housing 6, in particular a coil spring cassette 6, and which, as shown in FIG. 1, has electrically insulated conductors 18 and 19, in particular conductor tracks 18 and 19 running in parallel, in the example shown here a first conductor track 18 and a second conductor track 19. The conductor tracks 18, 19 can be arranged here in one or more planes (not shown) and can be insulated from each other.

The strip-type electrical transmission element 2, i.e., the coil spring, has a first strip end 11, in particular on the vehicle structure side, with a first connection region, not shown here, in particular on the vehicle structure side, and a second strip end 12, in particular on the steering input side, with a second connection region 23, in particular on the steering input side. As indicated by the arrow 60, an electrical connection to the component 3A arranged on the vehicle structure side or the assembly 3 is established via the first connection region. As indicated by the arrow 61, an electrical connection to the component 4A or the assembly 4 arranged on the steering input side, in particular on the steering wheel side, is established via the second connection region 23. The connection region 23 of the strip-type transmission element 2 on the steering input side is formed here by the conductor track ends 21 and 22 associated with the conductor tracks 18, 19—as can be clearly seen in FIG. 1.

This exemplary embodiment of an electrical transmission device 10 according to the invention has two electrical discharge devices 5, each of which is designed as an electronic component 7 or is formed in each case by an electronic component 7, presently in each case by a Zener diode 7 or alternatively a varistor, which is connected in each case accordingly for dissipation of electrostatic charges of the electrical transmission device 10.

The discharge devices 5 in the form of electronic components 7 are electrically connected here to the electrical transmission element 2, in particular contacted with the conductor track ends 21 and 22, in such a way that, in a functional installation state of the electrical transmission device 10 in the motor vehicle, an electrostatic charge of the electrical transmission device 10, in particular of the conductor tracks 18 and 19, can be dissipated at least partially via the electronic components 7.

In the example shown in FIG. 1, the electronic components 7 are arranged as discharge devices 5 in the region of the second strip end 12, in each case between a conductor track end 18 or 19 and a protective potential contact element 16, and in each case are electrically contacted with an associated conductor track end 18 or 19 and the protective potential contact element 16, in this case, for example, via corresponding solder contacts not specified in greater detail here.

The protective potential contact element 16 is electrically connected here via an electrical contact point 51 to a contact element 42 leading to an electrical ground GND of the motor vehicle, for example in the steering wheel region, in particular is electrically contacted with said contact element. The end regions of the conductor tracks 18 and 19 which terminate in the region of the second strip end 12 are furthermore electrically connected (for example via soldered connections), in particular are electrically contacted, via contact points 50, to/with electrically conductive contact elements 41 in the form of contact pins 41, which are plug pins 41, wherein the contact elements 41 are electrically connected to the component 4A arranged on the steering input side and/or to the assembly 4 arranged on the steering input side.

The contact elements 41 and the contact element 42 leading to ground GND are components of a connection device 30, in particular a plug device 30, which in the exemplary embodiment shown here is composed of a first connection portion 31, in particular a plug element 31, and a second connection portion 32, in particular a plug collar 34 formed in one piece with a plug plate 33.

In this case, the first connection portion 31 faces the second connection region 23 of the electrical transmission element 2 and is likewise arranged in the housing 6, wherein the connection region 23 extends with the conductor track ends 18 and 19 into the plug element 31. In this exemplary embodiment, the second connection portion 32 is a plug plate 33 inserted into a housing opening 8 and formed in one piece with a plug collar 34, wherein the plug collar 34 adjoins the plug plate 33 at the edge and extends perpendicularly and circumferentially in relation to the plug plate 33, wherein the plug plate 33 is in particular in the form of a circular disc, but alternatively can also be rectangular or the like.

Here, the contact elements 41, 42 each pierce the plug plate 33 at a right angle, in particular in openings provided specifically for this purpose, and form plug pins 41, 42 for establishing an electrically contacting plug-in connection with the connection device 30, in particular the second connection portion 32.

The ends 21, 22 of the conductor tracks 18, 19 arranged in the region of the second strip end 12 are in each case integrated in the connection device 30, in particular the first connection portion 31, or terminate in the first connection portion 31, wherein the ends 21 and 22 of the conductor tracks 18, 19 have been embedded in particular in the first connection portion 31 by overmolding, as have incidentally also the protective potential contact element 16 and the discharge devices 5.

Furthermore, in this exemplary embodiment, the two connection portions 31 and 32 each themselves form an electrical discharge device 31 and 33, 34, respectively, wherein they are made of an appropriately suitable material for this purpose and, in particular, have a high-resistance behavior, so that electrostatic charges can be dissipated and the useful signals can nevertheless be transmitted via the conductor tracks 18 and 19.

The high-resistance discharge devices 31, 33 and 34 formed by the connection portions 31 and 32 can optionally be made here of a material selected in such a way that the connection device 30, at least in portions, has a high resistance when a voltage below a defined voltage limit value is present and a low electrical resistance when a voltage above the defined voltage limit value is present.

Due to the arrangement and design of the discharge devices 5, 31, 33 and 34 selected in this exemplary embodiment, not only electrostatic charges from the strip-type transmission element 2, but also electrostatic charges of the housing 6 can be dissipated, the latter in particular via the connection device 30 in electrical contact with the housing 6, in particular through the connection portion 32.

By combining the various discharge devices 5, 31 and 34, a wide range of discharges can be realized, in particular without appreciably adversely affecting a useful function of the transmission device 10.

FIG. 2 is based fundamentally on the exemplary embodiment according to FIG. 1, wherein the connection device 30a on the vehicle structure side is now also shown at the belt end 11 on the vehicle structure side. The first and second conductor tracks 18, 19 are routed from the connection device 30 on the steering wheel side to the connection device 30a on the vehicle structure side. The connection device 30a on the vehicle structure side has a first connection portion 31a. In the first connection portion 31a on the vehicle structure side, the conductor tracks 18, 19 are connected to the contact elements 41a, 42a via the contact points 50a, 51a.

The contact elements 41a are led out of the first connection portion 31a through the plug plate 33a and into the second connection portion 32a. The second connection portion 32a on the vehicle structure side forms a plug receptacle with the contact elements 41a led out and the plug collar 34a, so that the electrical transmission device 10 can also be contacted on the vehicle structure side. For example, a cable with a corresponding plug can be inserted into the plug receptacle formed in order to connect a control unit on the vehicle structure side to an assembly provided on the steering wheel side via the electrical transmission device 10.

FIG. 3 shows a development of the exemplary embodiment according to FIG. 2. In this exemplary embodiment, in addition to the conductor tracks 18, 19, the protective potential contact element 16 is also routed in the sense of a third conductor track from the connection device 30 on the steering wheel side to the connection device 30a on the vehicle structure side. In the first connection portion 31a on the vehicle structure side, the protective potential contact element 16 is connected to the contact element 42a via the contact point 51a. Correspondingly to the contact elements 41a, the contact element 42a is also led out of the first connection portion 31a through the plug plate 33a and into the second connection portion 32a. This means that, for example, a protective potential or the ground potential can also be applied to the protective potential contact element 16 on the vehicle structure side.

### LIST OF REFERENCE SIGNS

10 electrical transmission device

2 electrical transmission element

3A component arranged on the vehicle structure side

3 assembly arranged on the vehicle structure side

4A component arranged on the steering input side

4 assembly arranged on the steering input side

5, 5a electrical discharge device

6 housing part

7, 7a electronic component

8 opening

11 first strip end

12 second strip end

16 protective potential contact element

18 first conductor track

19 second conductor track

21 end of the first conductor track on the steering input side

22 end of the second conductor track on the steering input side

23 second connection region

30 connection device on the steering input side

30a connection device on vehicle structure side

31 first connection portion on the steering input side

31a first connection portion on the vehicle structure side

32 second connection portion on the steering input side

32a second connection portion on the vehicle structure side

33, 33a plug plate

34, 34a plug collar

41, 42 contact element

50, 51 contact point

60, 61 electrical connection

GND ground

1. An electrical transmission device comprising a coil spring arrangement for a motor vehicle, the electrical transmission device comprising:
a strip-type electrical transmission element comprising a winding strip or a coil spring, which, in a functional installation state of the electrical transmission device in a motor vehicle, is configured to form an electrical connection for signal and/or energy transmission, between a component arranged on the vehicle structure side and a component arranged on the steering wheel side; and
at least one electrical discharge device for dissipating an electrostatic charge of the electrical transmission device, wherein the discharge device is electrically contacted with the strip-type electrical transmission element and is configured in such a way that an electrostatic charge of the electrical transmission device is dissipated at least partially via the electrical discharge device.

2. The electrical transmission device as claimed in claim 1, further comprising: at least one housing part of a housing for accommodating the strip-type transmission element, wherein the strip-type electrical transmission element is accommodated at least partially by the at least one housing part, wherein at least one discharge device is electrically connected to this at least one housing part in such a way that at least one electrostatic charge of the housing part is dissipated via the discharge device, which is electrically connected to the at least one housing part.

3. The electrical transmission device as claimed in claim 1, wherein the at least one electrical discharge device, in a functional installation state in a motor vehicle, is configured to be electrically connected to a defined protective potential so that, in a functional installation state of the electrical transmission device in a motor vehicle, an electrostatic charge of the strip-type transmission element and/or at least one housing part is dissipated at least partially via at least one electrical discharge device to the defined protective potential.

4. The electrical transmission device as claimed in claim 1, wherein the strip-type electrical transmission element has a first strip end on the vehicle structure side, with a first connection region on the vehicle structure side, and a second strip end on the steering input side, with a second connection region on the steering input side, wherein it is possible to establish an electrical connection via at least part of the first connection region, to a component arranged on the vehicle structure side and/or to an assembly arranged on the vehicle structure side, and wherein it is possible to establish an electrical connection via at least part of the second connection region, to the component arranged on the steering wheel side, wherein at least one discharge device is electrically connected to the electrical transmission element at least via a part of the first connection region and/or at least via a part of the second connection region, so that, in a functional installation state of the electrical transmission device in a motor vehicle, an electrostatic charge of the electrical transmission device is dissipated at least partially at least via the associated part of the first connection region and/or at least via the associated part of the second connection region and the at least one discharge device.

5. The electrical transmission device as claimed in claim 1, wherein the strip-type electrical transmission element has at least one conductor track having a first conductor track end and a second conductor track end, wherein the conductor track extends from the first strip end to the second strip end, wherein an end region at the first conductor track end and at the second conductor track end in each case forms part of the associated connection region of the strip-type transmission element, wherein at least one discharge device is electrically connected to the electrical transmission element via a first conductor track end or a second conductor track end, so that, in a functional installation state of the electrical transmission device in a motor vehicle, an electrostatic charge of the electrical transmission device is dissipated, at least partially, via at least one conductor track and at least one discharge device.

6. The electrical transmission device as claimed in claim 2, further comprising: at least one electrical connection device electrically connected to the strip-type transmission element comprising at least one plug device, via which the electrical transmission element is electrically connected to a component, wherein the connection device is electrically connected to the strip-type transmission element via the connection region of the strip end facing the connection device.

7. The electrical transmission device as claimed in claim 6, wherein the at least one connection device comprises at least one protective potential contact pin, wherein the at least one protective potential contact pin, in a functional installation state in a motor vehicle, is configured to be electrically connected to a defined protective potential, in particular to ground (GND),
wherein the at least one electrical discharge device of the transmission device is electrically connected to the at least one protective potential contact pin in such a way that, in a functional installation state of the electrical transmission device in a motor vehicle, an electrostatic charge of the electrical transmission device is dissipated at least partially via the discharge device and the associated protective potential contact pin to the defined protective potential.

8. The electrical transmission device as claimed in claim 6, wherein at least one connection device at least one plug device, is formed in multiple parts, wherein the connection device has a first connection portion a plug element, arranged facing the transmission element, and a second connection portion comprising a plug collar, arranged facing the associated component that is connected via the connection device, wherein the first connection portion and the second connection portion are electrically connected to one another via at least one contact element.

9. The electrical transmission device as claimed in claim 1, wherein at least one discharge device comprises at least one electronic component comprising an SMD component or a wired component selected from the group consisting of: an ohmic resistor, a varistor, a leakage diode and a Zener diode and/or a glow discharge gap and a spark gap formed therefrom.

10. The electrical transmission device as claimed in claim 9, wherein at least one discharge device at least one electronic component of the discharge device, is integrated at least partially into the connection device into the first connection portion.

11. The electrical transmission device as claimed in claim 6, wherein the at least one discharge device is formed at least partially by the connection device itself, by the first connection portion and/or the second connection portion of the connection device, wherein the connection device and the associated connection portion has a suitable coating which enables electrical discharge of an electrical charge.

12. The electrical transmission device as claimed in claim 6, wherein the connection device is at least partially accommodated by the housing part, wherein the connection device is accommodated in the housing part and electrically connected to the housing part when the at least one discharge device is formed at least partially by the connection device, in such a way that an electrical charge of the housing part is dissipated via the connection device.

13. The electrical transmission device as claimed in claim 1, wherein the at least one discharge device is configured with regard to its electrical conductivity and/or its electrical resistance, in such a way that, in a functional installation state of the electrical transmission device in a motor vehicle, a signal and/or energy transmission to a component electrically connected to the strip-type transmission element and/or to a assembly is at least substantially not impaired, wherein electrostatic charges can be dissipated at least to the extent that undesirable influence on and/or damage to the component electrically connected to the strip-type transmission element and/or to the assembly is avoided.

14. The electrical transmission device as claimed in claim 1, wherein the at least one discharge device is resistive, wherein the at least one resistive discharge device has a resistance of at least 0.1 MΩ, and at most of 100 MΩ.

15. The electrical transmission device as claimed in claim 1, wherein the at least one discharge device is at least partially non-resistive, and has an at least partially voltage-dependent electrical resistance, the discharge device being configured in such a way that
it has a high resistance in the presence of a voltage below a defined voltage limit value, and
it has a low electrical resistance in the presence of a voltage above the defined voltage limit value.

16. The electrical transmission device as claimed in claim 14, further comprising at least one resistive discharge device and at least one non-resistive discharge device,
wherein the at least one resistive discharge device comprises at least one electronic component or consists of at least one electronic component, and
wherein the at least one non-resistive discharge device is at least partially formed by at least one connection device on the steering input side, which connection device is made of a material and/or has a coating which is selected to have a high resistance in the presence of a voltage below a defined voltage limit value and to have a low electrical resistance in the presence of a voltage above the defined voltage limit value.

17. A motor vehicle comprising an electrical transmission device wherein the transmission device is formed as claimed in claim 1.
